(19) United States
(12) Patent Application Publication
(10) Pub. No.: US 2004/0252930 A1
(43) Pub. Date: Dec. 16, 2004

(54) Sensor or a microphone having such a sensor

(76) Inventors: Vladimir Gorelik, Hannover (DE); Andre Michaelis, Wedemark (DE); Manfred Hibbing, Wedemark (DE); Wolfgang Niehoff, Wedemark (DE); Gerd Marowsky, Goettingen (DE); Ruth Weichenhain, Goettingen (DE); Juergen Ihlemann, Goettingen (DE); Marco Feldmann, Braunschweig (DE); Stephanus Buettgenbach, Sickte (DE); Sergey Kudaev, Jena (DE); Peter Schreiber, Jena (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/815,503

(22) Filed: Mar. 31, 2004

(30) Foreign Application Priority Data
Mar. 31, 2003 (DE) 103 14 731.4

(51) Int. Cl. G02B 6/00

(52) U.S. Cl. 385/12

(57) ABSTRACT

The invention relates to a sensor or a microphone having such a sensor. The object of the present invention is to improve the degree of development of the sensor or an optical microphone as an air-borne sound sensor. A sensor consisting of a diaphragm, wherein at least on one side the diaphragm comprises a surface which reflects a light beam, wherein on this side a first optical waveguide is constructed as a transmitting waveguide, through which a light beam passes and strikes against the diaphragm, wherein a second optical waveguide constructed at a specific angular relationship to the first optical waveguide is provided, which has the function of a receiving waveguide and into which light reflected from the diaphragm enters, an optical element is constructed in the light path between the transmitting waveguide and the receiving waveguide, by which the light beam is bunched or focussed.

### CROSS-REFERENCE TO RELATED APPLICATIONS

This application claims priority of German Application No. 103 14 731.4, filed Mar. 31, 2003, the complete disclosure of which is hereby incorporated by reference.

### BACKGROUND OF THE INVENTION

a) Field of the Invention

The invention relates to a sensor or a microphone having such a sensor.

b) Description of the Related Art

Sensors and optical microphones of the above type are already known from DE 198 35 947 A1 and “ACUSTICA”, International Journal on Acoustics, Vol. 73, 1991, pages 72 to 89 and also U.S. Pat. No. 3,622,791, GARTH, D.: Ein rein optisches Mikrofon (a purely optical microphone), in Acustica, Vol. 73, 1991, page 72-89. Reference is made to DE 198 26 565, EP-A1-1 191 812 and U.S. Pat. No. 5,262,884 as further prior art.

It is possible to convert a sound signal into an electromagnetic signal by using very different methods, as is known. Apart from the known dynamic microphones and capacitor microphones (electric microphones), the optical microphone known from the prior art is distinguished by insensitivity to electric and magnetic fields and thus also by a particularly transmission with immunity to interference.

An optical microphone is an airborne sound sensor in which light conveyed in glass fibers is modulated by incident sound. In the case of intensity-modulating diaphragm scanners, the coupling takes place between two optical waveguides, a transmitting waveguide and a receiving waveguide. Light from the transmitting waveguide strikes against the diaphragm surface, which preferably comprises a reflecting surface. From there the reflected light strikes against the receiving waveguide and, depending on the diaphragm deflection, the amount of incident light at the receiving waveguide is adjusted. In the case of the intensity-modulating diaphragm scanning, the coupling takes place between two optical waveguides. With the diaphragm deflection, the degree of coupling and the bunched (luminous) power changes. This modulator can be produced in different ways, e.g. as a multimode fiber, a monomode fiber, etc.

It is possible to arrange the transmitting waveguide and the receiving waveguide, which are made e.g. from a common glass fiber or SU8, at any angle in relation to the diaphragm.

### OBJECT AND SUMMARY OF THE INVENTION

The primary object of the present invention is to improve the degree of development of the sensor or of an optical microphone as an airborne sound sensor.

The object of the invention is achieved in accordance with the invention in that a sensor comprises a diaphragm, wherein at least on one side the diaphragm further comprises a surface which reflects a light beam. A first optical waveguide is constructed on the side as a transmitting waveguide through which a light beam passes and strikes against the diaphragm. A second optical waveguide is constructed at a specific angular relationship with respect to the first optical waveguide. The second optical waveguide has the function of a receiving waveguide and into which light reflected from the diaphragm enters. Optical means are constructed in the light path between the diaphragm and the receiving waveguide in such a manner that the light beam is focussed onto the end face of the receiving waveguide by the optical means.

### BRIEF DESCRIPTION OF THE DRAWINGS

In the drawings:

FIG. 1 is a side pictorial view showing how an optical focusing means is inserted in the light path between the transmitting waveguide of the invention;

FIG. 2 is a side pictorial view showing the placing of the optically focusing means at the output of the transmitting waveguide;

FIG. 3 is a side representational view showing the arrangement geometry in accordance with the invention; and

FIG. 4 illustrates another embodiment according to the invention in which a diffractive reflective structure is applied to the side of the diaphragm closer to the waveguides.

### DESCRIPTION OF THE PREFERRED EMBODIMENTS

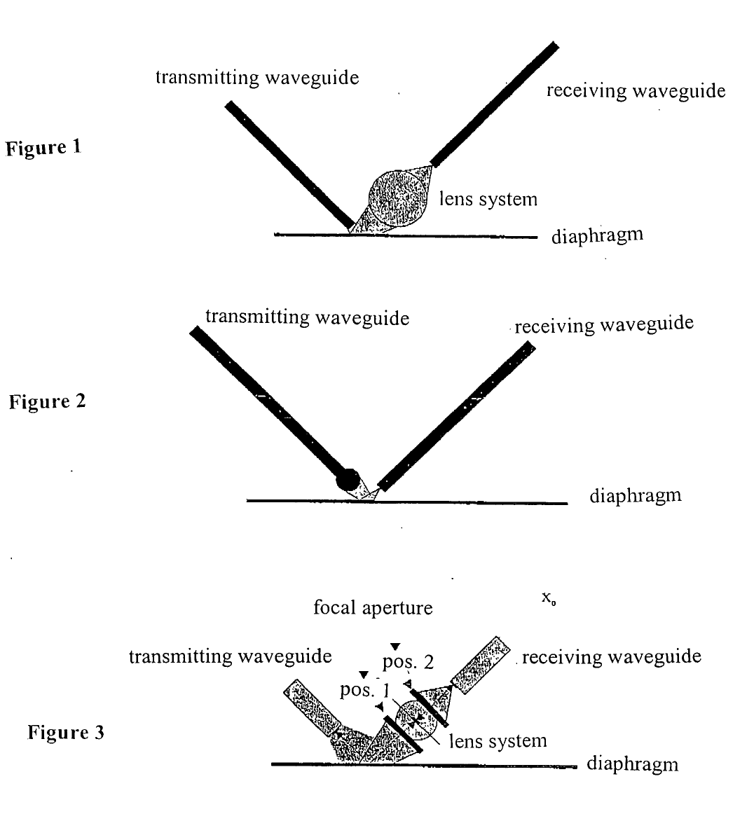

The efficiency of the microphone according to the invention is increased by virtue of the focusing of the radiation by optical elements which are positioned in the beam path in front of and behind the diaphragm. The beam cross section is reduced at the site of the receiving waveguide by means of focusing lens systems, e.g. by melting on the waveguides, as is also represented in FIGS. 1 and 2.

FIG. 1 shows how an optically focusing means is inserted in the light path between the transmitting waveguide and the receiving waveguide, and FIG. 2 shows that this optically focusing means is placed at the output of the transmitting waveguide, e.g. is melted on. However, another fixing is possible.

The use of focal apertures in the beam path results in a reduction of the image defects and thus in a reduction in the beam diameter. The size of the focal apertures and their position in the beam path is predetermined by the arrangement geometry and the beam properties (see also FIG. 3).

Apart from the use of glass fibers and a lens system made of glass, which can be embedded in a mounting made of SU8, the waveguides and the lens system can also be made of a photoresist (SU8) and thus be directly positioned on the mounting in front of the vibrating diaphragm.

The described waveguides can be SiO₂ fibers, polymer strip lines (SDU8), inorganic strip lines or the like. The arrangement of these above-mentioned waveguides is bent parallel, but the receiving fibers may also be disposed concentrically around the transmitting fibers. The described lens systems may be spherical lenses, biconvex or planoconvex lenses, and cylinder lenses or lenses made from SU8 are also possible. Apart from the previously described external microoptical components, other integrated microoptical components may also be provided, in which case these may be lens systems which are diffractive as a result of the structuring of the fiber ends (cylinder lenses/spherical lenses) or fire polishing or thin-drawing, or by drop application, layer application, prism application.

The conversion of a sound signal into an electromagnetic signal takes place by various methods. Apart from the known methods of dynamic microphones or capacitor microphones, the optical microphone according to the invention is distinguished by insensitivity to electrical and magnetic fields and the resultant special signal transmission with immunity to interference. The described optical microphone according to the invention (sensor) is an airborne noise sensor, in which light conveyed in glass fibers is modulated by the incident sound. During the intensity-modulating diaphragm scanning (the diaphragm is the only movable part of the arrangement), the coupling takes place between two optical waveguides. If the diaphragm is deflected, the degree of coupling (degree of overlap) and the bunched power (of the light) changes. This modulator can be produced in various ways (multimode fiber, monomode fiber, with and without beam focusing, as a free-space structure or integrated optically).

It is possible to arrange the waveguides at any angle in relation to the diaphragm, as FIG. 1 shows. The efficiency of the microphone is increased by virtue of the focusing of the beam path by optical elements which are positioned in the beam path in front or or/and behind the diaphragm. By means of focusing lens systems or the melting of the waveguide, the beam cross section at the site of the receiving waveguide is reduced, as FIG. 2 shows. The use of focal apertures in the beam path results in a reduction of the image defects and thus in a reduction in the beam diameter. The size of the focal aperture and its position in the beam path is predetermined by the geometry of the arrangement and the radiation properties, as FIG. 3 shows.

An important advantage of the previously described method according to the invention is that the ratio of the signal-to-noise distance is improved in comparison with previous achievements of this type. However, above all, the achievement according to the invention is very simple and therefore highly effective.

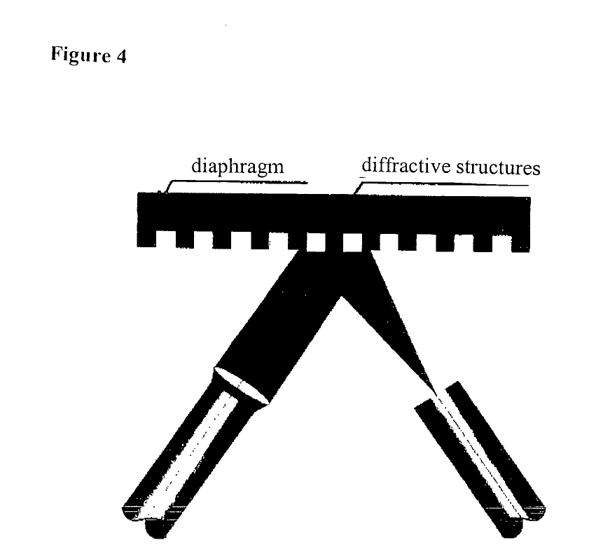

FIG. 4 shows another embodiment according to the invention in which a diffractive, reflective structure is applied to the side of the diaphragm closer to the waveguides.

While the foregoing description and drawings represent the present invention, it will be obvious to those skilled in the art that various changes may be made therein without departing from the true spirit and scope of the invention.

What is claimed is:

1. A sensor comprising:
a diaphragm, wherein at least on one side the diaphragm further comprises a surface which reflects a light beam;
a first optical waveguide being constructed on said side as a transmitting waveguide, through which a light beam passes and strikes against the diaphragm;
a second optical waveguide being constructed at a specific angular relationship with respect to the first optical waveguide, said second optical waveguide having the function of a receiving waveguide and into which light reflected from the diaphragm enters; and
optical means being constructed in the light path between said diaphragm and said receiving waveguide in such a manner that the light beam is focussed onto the end face of the receiving waveguide by said optical means.

2. The sensor according to claim 1, wherein the sensor is a microphone.

3. The sensor according to claim 1, wherein said means for beam focusing comprises a focusing lens system, which is melted onto the output of the transmitting waveguide.

4. The sensor according to claim 1, wherein the focusing lens system is a glass body.

5. The sensor according to claim 1, wherein the focusing lens system is a spherical lens, a biconvex or a planoconvex lens, a cylinder lens or a lens made from SU8.

6. The sensor according to claim 1, wherein the focusing lens system is drop-shaped and/or has a circular cross section.
